(19) United States
(12) Patent Application Publication
(10) Pub. No.: US 2009/0054151 A1
(43) Pub. Date: Feb. 26, 2009

(54) Game Topper

(76) Inventors: Gene Estep, Shawnee, OK (US); Fredrick C. Combs, Shawnee, OK (US)

Correspondence Address: FISH & RICHARDSON P.C., PO BOX 1022, MINNEAPOLIS, MN, 55440-1022, US

(21) Appl. No.: 12/184,867

(22) Filed: Aug. 1, 2008

Related U.S. Application Data
(60) Provisional application No. 60/953,380, filed on Aug. 1, 2007.

(51) Int. Cl. G06F 17/00

(52) U.S. Cl. 463/42

(57) ABSTRACT

The subject matter of this specification can be embodied in, among other things, a method that includes monitoring, at a game topper, a signal transmitted between a gaming device and a remote gaming management system, associating at least a portion of the signal with media, and outputting the media to a user of the gaming device using the game topper.

### CROSS REFERENCE TO RELATED APPLICATIONS

This application is a utility application of and claims priority to U.S. Patent Application Ser. No. 60/953,380, filed Aug. 1, 2007.

### TECHNICAL FIELD

This instant specification relates to displaying information associated with a gaming device.

### BACKGROUND

Some gaming devices may have integrated displays that show images or play sounds, while other gaming devices do not have integrated displays. Gaming devices having the integrated displays may attract more players because of the visual or audio media played by the gaming device.

For gaming devices that have integrated displays, modifying the images or sounds output by the gaming device may require reprogramming the gaming device, which may, in turn require recertification of the gaming device because of regulations associated with gaming devices.

### SUMMARY

In general, this document describes a portable media output device for use with gaming devices.

In a first general aspect, a computer-implemented method is described. The method include monitoring, at a game topper, a signal transmitted between a gaming device and a remote gaming management system, associating at least a portion of the signal with media, and outputting the media to a user of the gaming device using the game topper.

In a second general aspect, a system is described. The system includes an interface for receiving a signal transmitted between a gaming device and a remote gaming management system, a signal decoder for associating at least a portion of the signal with media, and a media output device for outputting the media to a user of the gaming device.

The systems and techniques described here may provide one or more of the following advantages. First, a gaming device without an integrated display can be upgraded to include a display and speakers. Second, images and audio can be played in real-time based on events that occur while a player is using the gaming device. Third, media that is played can be modified without modifying the gaming device. Fourth, a game topper can be added to a variety of gaming devices, regardless of what gaming protocol a gaming device uses.

The details of one or more implementations of the feature are set forth in the accompanying drawings and the description below. Other features and advantages will be apparent from the description and drawings, and from the claims.

### DESCRIPTION OF DRAWINGS

FIG. 1 is a schematic diagram showing an example of a system for outputting media to a user of a gaming device using a game topper.

FIG. 2 is a schematic diagram showing an example of a game topper for outputting media to a user of a gaming device.

FIG. 3 is a block diagram showing an example of a system for outputting media to a user of a gaming device using a game topper.

FIG. 4 is a flow chart showing an example of a process for outputting media to a user of a gaming device using a game topper.

FIG. 5 is a schematic diagram of a computing system that can be used in connection with computer-implemented methods described in this document.

Like reference symbols in the various drawings indicate like elements.

### DETAILED DESCRIPTION

This document describes systems and techniques for outputting media to a user of a gaming device using a game topper. In some implementations, the game topper monitors a signal between the gaming device and a remote gaming management system. The game topper associates at least a portion of the signal with media and can output the media to a user. For example, the gaming device may be a slot machine having a slot machine topper that displays messages to the user based on an occurrence of gaming events.

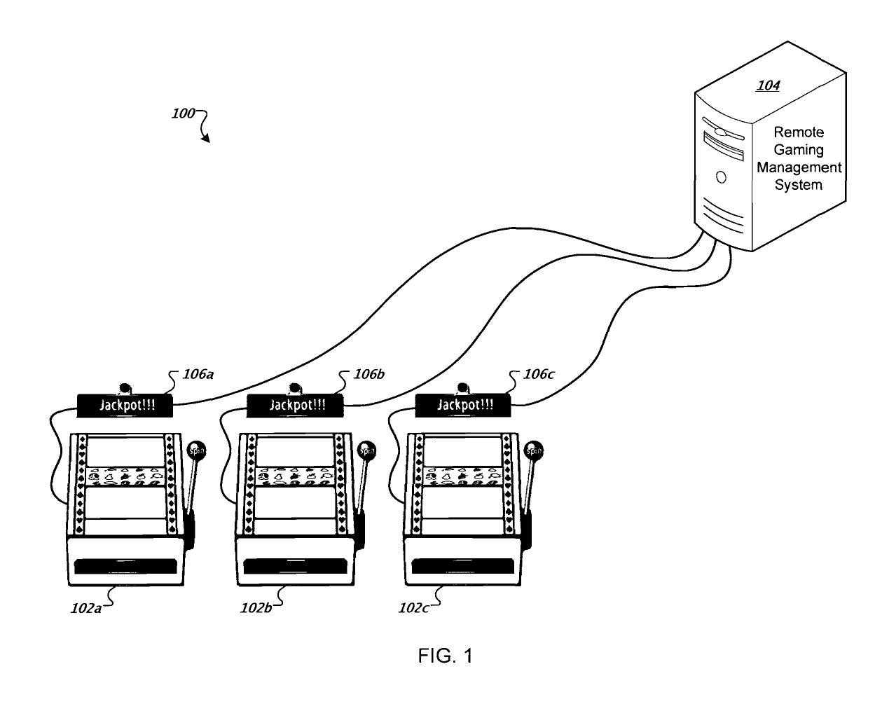

FIG. 1 is a schematic diagram showing an example of a system 100 for outputting media to a user of a gaming device using a game topper. The system 100 includes one or more gaming devices 102a-c. In some implementations, the gaming devices 102a-c are in communication with a remote gaming management system 104. In some implementations, the remote gaming management system 104 includes accounting and other data collection software. For example, the remote gaming management system 104 can record cash in/out for a game, a number of wins per time period, running jackpot amounts for progressive jackpots, etc. In other implementations the gaming management system 104 can also manage promotions intended to attract players to gaming devices or the casino. In yet other implementations, the gaming management system 104 can also track statistics related to players (e.g., amount won or lost, favorite gaming devices, frequency of play, etc.). The gaming management system 104 can also generate reporting information, such as accounting information, for all or a portion of the gaming devices.

The gaming management system 104 may also include cash/cage/vault management functionality, create promotional tickets for the casino, schedule marketing campaigns and track their performance over a period of time (or in real-time) through monitoring game play on the gaming devices.

One example of a remote gaming management system is TAHOE SYSTEM available from EC Development of Shawnee, Okla. The gaming devices 102a-c send information to the remote gaming management system 104, such as an identity of a user playing the gaming device or results of a game play session of the user. The gaming devices 102a-c have associated game toppers 106a-c. The game toppers 106a-c present media to users at the gaming devices 102a-c, respectively, such as images, video, audio, and text.

In some implementations, the game toppers 106a-c passively monitor the communication between the gaming devices 102a-c, respectively, and the remote gaming management system 104. For example, the gaming devices 102a-c may have cable connections to the remote gaming management system 104 (or another data concentrator device), such as serial connections. Each of the connections from the gaming devices 102a-c may first connect to the game toppers 106a-c, respectively, and the game toppers 106a-c are then connected to the remote gaming management system 104. The game toppers 106a-c may pass signals received from the gaming devices 102a-c, respectively, through to the remote gaming management system 104.

In some implementations, a game topper, such as the game topper 106a, identifies at least a portion of a signal passed to the remote gaming management system 104. For example, the game topper 106a can identify a field within a system-to-system (S2S) encoded signal. The game topper 106a can also identify media associated with the signal portion and output the media to a user of the gaming device 102a. For example, the field (or data in the field) can be associated with an audio file so that whenever the field (or data within the field) occurs, the audio file is played to a user of the gaming device 102a.

In some implementations, the game toppers 106a-c are in communication with the gaming devices 102a-c and/or the remote gaming management system 104 through a network, such as a Transmission Control Protocol/Internet Protocol (TCP/IP) network. The remote gaming management system 104 can relay information received from the gaming devices 102a-c to the game toppers 106a-c, respectively. Alternatively, the gaming devices 102a-c can send information to the game toppers 106a-c, respectively, and the game toppers 106a-c may relay the information to the remote gaming management system 104. Again, a game topper, such as the game topper 106a, can monitor signals received from or transmitted to a gaming device. In some implementations, based on this monitoring, the game topper 106a identifies media associated with a portion of the monitored signal and outputs the media to a user of the gaming device 102a.

In certain implementations, the gaming devices 102a-c are connected to the game toppers 106a-c, respectively, using a connection, such as serial connections, and the game toppers 106a-c are in communication with the remote gaming management system 104 through a network, such as a TCP/IP network. For example, the gaming devices 102a-c can connect to the game toppers 106a-c through a serial connection and the game toppers 106a-c can connect to the remote gaming management system 104 using an Ethernet connection. This may provide a system and method of upgrading the connections from the gaming devices 102a-c to the remote gaming management system 104 by using the game toppers 106a-c as an interface or adapter.

In some implementations, the game toppers 106a-c can perform protocol or other connection conversions so that the signals from the gaming devices 102a-c are compatible with the remote gaming management system 104. For example, the game topper 106a can translate the information transmitted by a serial protocol to an Ethernet protocol. As such, the game toppers 106a-c may receive signals from the gaming devices 102a-c. The game toppers 106a-c monitor the signals and package the signals for transmission over the network to the remote gaming management system 104. The game toppers 106a-c identify media associated with portions of the signals and output the media to users of the game toppers 106a-c.

In some implementations, the system 100 uses one or more gaming industry protocols, such as the Slot Accounting System (SAS) provided by International Gaming Technology (IGT) or Game-to-System (G2S)/System-to-System (S2S) provided by the Gaming Standards Association (GSA). For example, in a pass through system, the gaming devices 102a-c may communicate with the remote gaming management system 104 using the SAS or G2S protocols while the game toppers 106a-c passively monitor the signals. In another example, the game toppers 106a-c may communicate with the gaming devices 102a-c using the SAS or G2S protocols and the game toppers 106a-c may communicate with the remote gaming management system 104 using the S2S protocol. In other implementations, the game toppers 106a-c can translate between various gaming protocols so that the remote gaming management system 104 can receive the information from the gaming devices 102a-c even if the gaming devices 102a-c use a protocol not used by the remote gaming management system 104. For example, the game topper 106a may receive an SAS signal from the gaming device 102a, translate the SAS signal into a G2S signal, and send the G2S signal to the remote gaming management system 104.

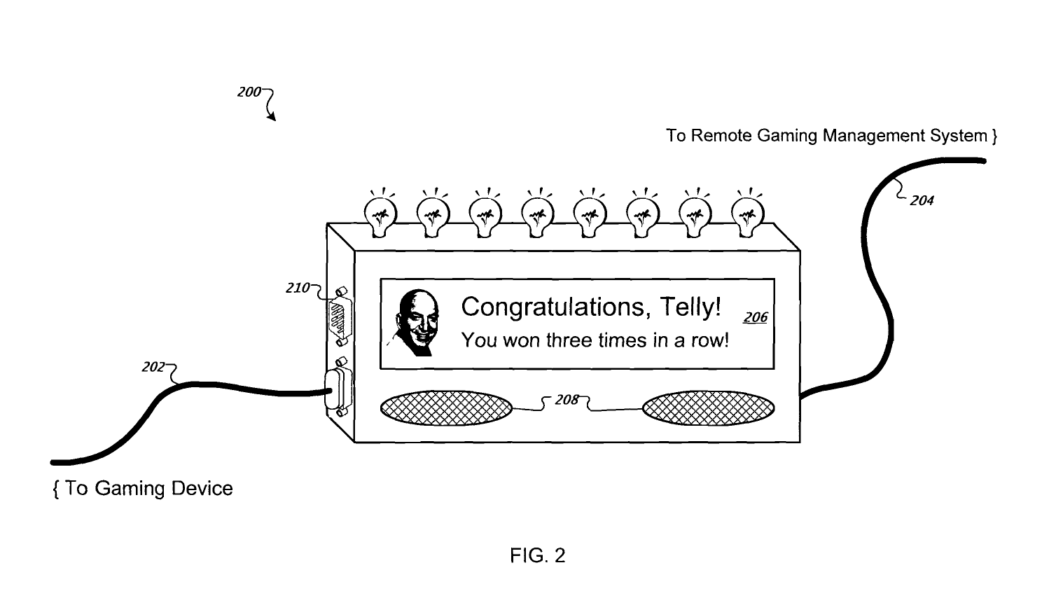

FIG. 2 is a schematic diagram showing an example of a game topper 200 for outputting media to a user of a gaming device. The game topper 200 receives a signal from a gaming device through a first connection 202. The game topper 200 can pass the signal to a remote gaming management system through a second connection 204. The game topper 200 can present visual media, such as a video or an image, associated with a portion of the signal. The game topper 200 can display the visual media using a display device 206 and audio media associated with the portion of the signal using an audio device 208.

In other implementations, the signal is intercepted by the game topper instead of passing through the game topper via the first and second connections 202, 204. For example, the gaming device 102a and the remote gaming management system 104 can communicate wirelessly, and the game topper 200 can intercept the wireless signal. In another implementation, the signal can be transmitted through the game topper using a combination of both wireless and wire-line connections. For example, the gaming device 102a can plug into the game topper 200, which transmits the signal wirelessly to the remote gaming management system 104.

In certain implementations, media for presentation at the game topper 200 is stored at the game topper 200, such as in an internal memory. In some implementations, media for presentation at the game topper 200 is stored at a remote gaming management system, such as the system 104. The system 104 can transmit media to the game topper 200 in response to receiving the signal from the gaming device, such as the gaming device 102a. In some implementations, the game topper 200 includes an interface 210, such as a Recommended Standard 232 (RS-232) serial port or a Universal Serial Bus (USB) port, or a wireless connection, for transferring media to the game topper 200. For example, a member of the casino staff can update video files that are played when a user hits a jackpot by connecting a laptop to the game topper through the interface 210.

In some implementations, the media is created in response to receiving the portion of the signal, either at the game topper 200 or the remote gaming management system 104. For example, a user identifier (ID) within the signal portion may be used to retrieve a name of the user. The user name and session play information may be presented using the game topper 200. For example, the display may show the user's name and a ranking of the user's winnings compared to other players of the game. In addition, audio media may be generated in response to the signal portion, such as a text-to-speech conversion of the user name. For example, the game topper can “speak” the user's name along with a message, such as “You've just won one hundred dollars!”

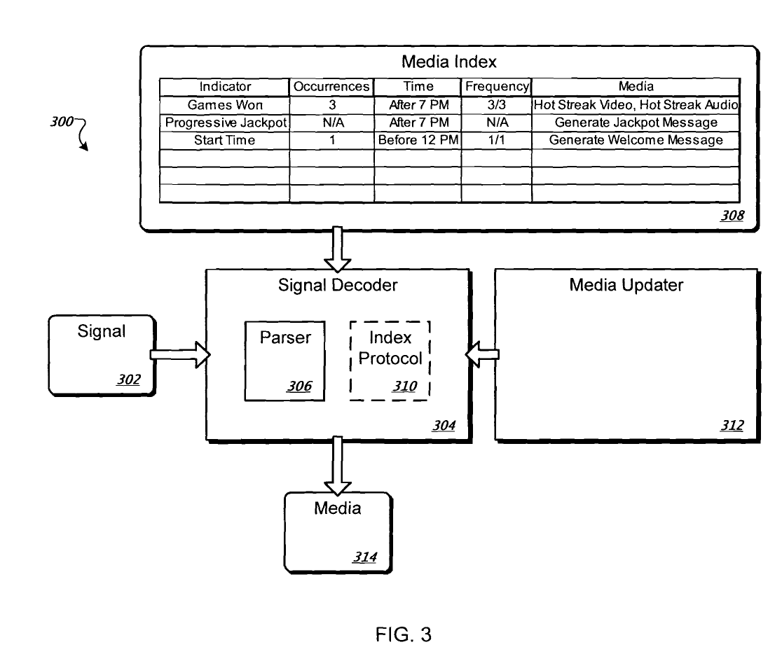

FIG. 3 is a block diagram showing an example of a system 300 for outputting media to a user of a gaming device using a game topper. The system 300 may be included within the game topper 200 and/or the remote gaming management system 104. The system 300 receives a signal 302 from a gaming device. The signal 302 can include game play session information, such as an ID of the session, a start time of the session, and end time of the session, a player ID, a cash in amount (e.g., the amount of money the player has provided for play), a cash out amount (e.g., the amount of money the player may take away), a number of games played in this session, a number of games won in this session, a cash played amount (e.g., an amount of money the player has provided for play together with an amount of money the player has won and used to play), and a number of points earned this session (e.g., points in a player reward system). While the preceding examples use money as an example, some implementations may use other gaming prizes, such as points in a reward system or credits/debits to an account.

In the example of FIG. 3, a signal decoder 304 receives the signal 302. The signal decoder 304 can include a parser 306 that parses the signal 302. For example, the parser 306 may identify one or more portions of the signal 302 that may be associated with media for presentation. In some implementations, the signal decoder 304 compares the identified signal portion to signal information in a media index 308. If one or more signal portions match signal conditions in the media index 308, then the signal decoder 304 can, in some implementations, retrieve the media associated with the signal conditions.

For example, the parser 306 may identify a “games won” field of the signal 302. The signal decoder 304 determines if the number of games won meets the “games won” condition in the media index 308. If the games won field indicates that the user has won three times and the winning occurrences have a frequency of three wins out of three plays, then the signal decoder 304 outputs a “hot streak” video and audio associated with the “games won” field and information. In addition, signal portions or other information may be used in combination within a condition. For example, the “games won” condition is only satisfied (and the “hot streak” video is only played) when the corresponding signal portion occurs after seven o'clock in the evening.

In another example, a signal portion, or information from the remote gaming management system 104 or a gaming device, may indicate that a player has won a progressive jackpot. The signal decoder 304 retrieves and presents the associated progressive jackpot message to a player using a game topper.

In another example, the signal decoder 304 determines that a player has started playing and presents a personalized greeting to the player based on the time of day and the name of the user. For example, the signal decoder 304 may generate a message such as, “Good morning John!” The signal decoder 304 may store player information or may retrieve player information from the remote gaming management system 104. Player information may include information that describes the player. For example, the player information may include a player ID, a full name, a first name, a last name, a middle initial, a password, a street address, a city, a state, a postal code, a gender, a height, a weight, a race/ethnicity, a hair color, an eye color, a social security number, a driver's license number, a date of birth, a home telephone number, a cellular telephone number, an electronic mail address, a favorite game, a favorite vendor ID, an average wager amount, an average hit percentage, a total number of games played, a total number of games won, a total cash in amount, a total cash played amount, a player card ID, a highest amount of player points received, a current balance of player points, and a date of a last activity for the player.

In some implementations, historical session play information may be stored in the remote gaming management system 104. Previously stored signal portions may be retrieved from the remote gaming management system 104 and used to generate media presentations. For example, the remote gaming management system 104 may determine that a user has incurred three “hot streaks” in there lifetime of playing a particular game. The remote gaming management system 104 can generate a corresponding message, such as, “You have three lifetime Hot Streaks!” The remote gaming management system 104 can output the message to the game topper 200 where the message is presented to the user.

Information in the previously described play session information and the player information may be used to generate media for presentation to the player. For example, using the player date of birth, the signal decoder 304 may generate and present a birthday greeting to a player on the birthday of the player. In another example, the signal decoder 304 can transmit a request to the remote gaming management system 104 for a free game play for the game. If approved, the game topper 200 can present a message indicating that the player has received free play for his/her birthday.

In some implementations, the signal decoder 304 and/or remote gaming management system 104 can identify and/or generate media for presentation using devices other than game toppers. For example, the remote gaming management system 104 may schedule a transmission of a message, such as a Short Message Service (SMS) message, to the cellular telephone of a player after a particular period of time expires or on a particular day and time.

For example, previously received signal portions may indicate that a user plays on a particular day of the week. The remote gaming management system 104 may send a message to the player if the player does not initiate a play session on the particular day. The message may include, for example, an incentive to play a game, such as a free play. Alternatively, a message, such as an incentive, may be sent if a player does not return within a particular amount of time, such as a week. In another example, the remote gaming management system 104 may determine that a current total number of play sessions for all players does not meet a particular minimum number of sessions. The remote gaming management system 104 may send one or more messages to players requesting that the players play a game and/or presenting an incentive to the players.

In some implementations, the media index 308 may use a set of conditions or a format that differs from those of the signal 302. The signal decoder 304 may include an index protocol 310 that translates information in the signal 302 into a format used by the media index 308.

The media index 308 may be updated by a media updater 312. For example, the media updater 312 can add, remove, or modify a condition in the media index 308. Where media is stored at the game topper 200, the media updater 312 can upload media to the game topper 200, for example, when media is added, removed, or modified.

In certain implementations, the media updater 312 may periodically check for media changes, for example, in a repository at the remote gaming management system 104 and update the media index 308 with the changes. Alternatively. or in addition, the media updater 312 may update the media index 308 when a particular event occurs, such as the receipt of a message from the remote gaming management system 104. The media updater 312 may use the connection used by the signal 302 or a separate connection to receive media changes. The connection may be wire-line or wireless. For example, the game topper 200 can have an Ethernet port. The Ethernet port can be used to communication with a laptop. The laptop can be used to update the media index 308. In another example, the game topper 200 can include a wireless transceiver used to communicate wirelessly with one or more computing devices that update the media index 308.

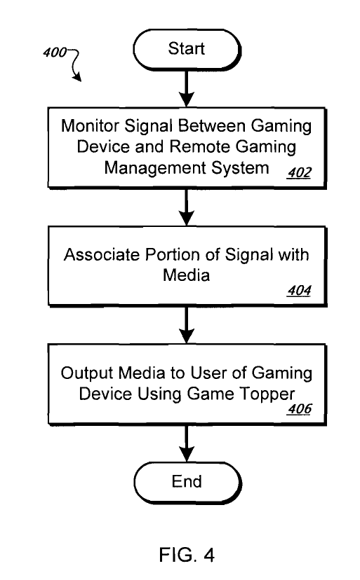

FIG. 4 is a flow chart showing an example of a process 400 for outputting media to a user of a gaming device using a game topper. The process 400 may be performed, for example, by a system such as the systems 100, 200, or 300. For clarity of presentation, the description that follows uses the systems 100, 200, and 300 as the basis of an example for describing the process 400. However, another system, or combination of systems, may be used to perform the process 400.

The process 400 begins with a game topper monitoring (402) a signal between a gaming device and a remote gaming management system. For example, the game topper 106a may monitor the signal between the gaming device 102a and the remote gaming management system 104.

The process 400 associates (404) at least a portion of the signal with media. For example, the system 300 associated a “games won” portion of the signal 302 with a “games won” condition and corresponding “hot streak” media in the media index 308.

The process 400 outputs (406) the media to a user of the gaming device using the game topper. For example, the game topper 200 outputs visual media using the display device 206 and audio media using the audio device 208.

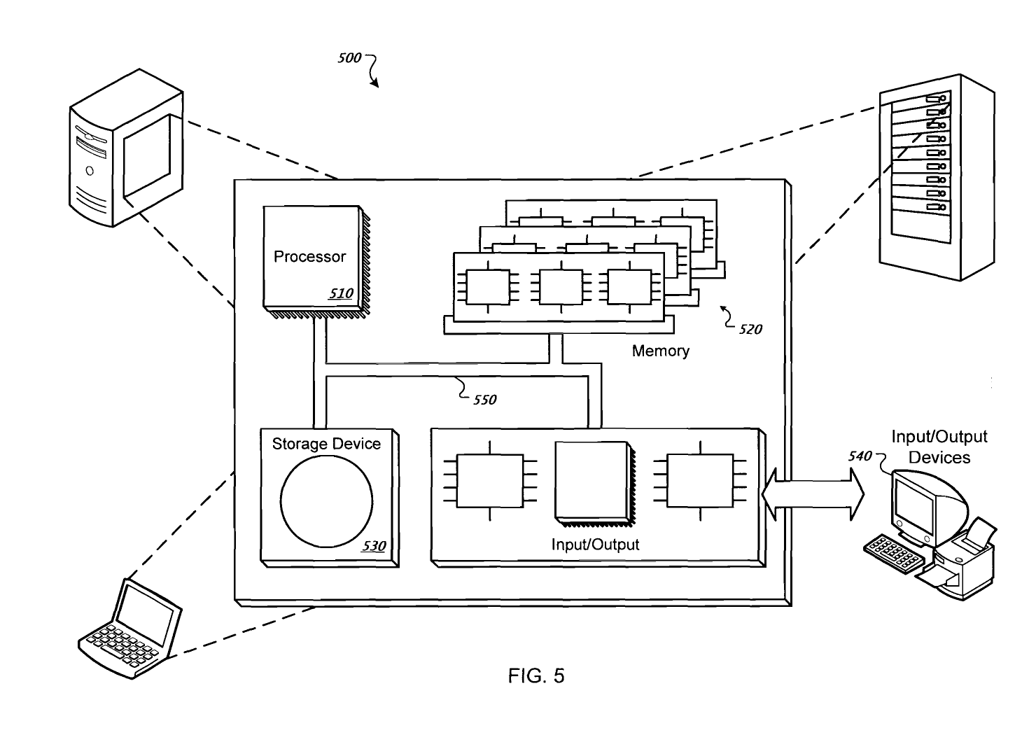

FIG. 5 is a schematic diagram of a computer system 500. The system 500 can be used for the operations described in association with any of the computer-implement methods described previously, according to one implementation. The system 500 includes a processor 510, a memory 520, a storage device 530, and an input/output device 540. Each of the components 510, 520, 530, and 540 are interconnected using a system bus 550. The processor 510 is capable of processing instructions for execution within the system 500. In one implementation, the processor 510 is a single-threaded processor. In another implementation, the processor 510 is a multi-threaded processor. The processor 510 is capable of processing instructions stored in the memory 520 or on the storage device 530 to display graphical information for a user interface on the input/output device 540.

The memory 520 stores information within the system 500. In one implementation, the memory 520 is a computer-readable medium. In one implementation, the memory 520 is a volatile memory unit. In another implementation, the memory 520 is a non-volatile memory unit.

The storage device 530 is capable of providing mass storage for the system 500. In one implementation, the storage device 530 is a computer-readable medium. In various different implementations, the storage device 530 may be a floppy disk device, a hard disk device, an optical disk device, or a tape device.

The input/output device 540 provides input/output operations for the system 500. In one implementation, the input/output device 540 includes a keyboard and/or pointing device. In another implementation, the input/output device 540 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier, e.g., in a machine-readable storage device or in a propagated signal, for execution by a programmable processor; and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

Although a few implementations have been described in detail above, other modifications are possible. For example, media associated with a particular user event can be presented using a game topper directed at another user or a display/audio device that presents media to one or more users, such as at an entrance to a casino (e.g., wins for all players in the casino can be presented at the entrance of the casino, such as on a scrolling marquee). In another example, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

What is claimed is:

1. A computer-implemented method comprising:
monitoring, at a game topper associated with a gaming device, a signal transmitted between the gaming device and a remote gaming management system that collects gaming-related information from one or more gaming devices;
associating at least a portion of the signal with media;
outputting the media to a user of the gaming device using the game topper.

2. The method of claim 1, further comprising generating at least a portion of the media output to the user.

3. The method of claim 1, further comprising identifying, within a storage device at the game topper, a portion of the media output to the user.

4. The method of claim 1, further comprising identifying, within a storage device at a computing device external to the game topper, at least a portion of the media output to the user.

5. The method of claim 1, wherein the media comprises one or more images, sounds, or videos.

6. The method of claim 1, wherein the signals are encoded using a gaming protocol.

7. The method of claim 6, wherein the gaming protocol comprises Slot Accounting System (SAS) protocol, Game-to-System (G2S) protocol, or System-to-System (S2S) protocol.

8. The method of claim 1, further comprising receiving the signal encoded in a first protocol and re-encoding the signal in a second protocol.

9. The method of claim 1, wherein the portion of the signal comprises a game play indicator that specifies one or more events associated with a game session for the gaming device.

10. The method of claim 9, wherein the game play indicator comprises a bonus indicator specifying a bonus to be paid to the user, a jackpot indicator specifying a jackpot to be paid to the user, and a winnings indictor specifying an amount won by the user over a time period.

11. The method of claim 1, wherein the portion of the signal comprises a game player indicator that specifies information associated with the user.

12. The method of claim 11, wherein the game player indicator comprises a user identifier, a player winnings indictor that specifies the user's winnings over a time period, a game winnings indicator that specifies the user's winnings for a session of a game, and a status indicator that specifies a user's ranking in winnings relative to other players.

13. The method of claim 1, wherein associating the portion of the signal with the media comprises determining the media to associate based on one or more user input conditions stored at the game topper and information extracted from the portion of the signal.

14. The method of claim 1, further comprising tracking events occurring at the gaming device for financial accounting purposes using the remote gaming management system.

15. The method of claim 1, further comprising uploading at least a portion of the media from the remote gaming management system using a connection configured to transmit the signal.

16. The method of claim 1, further comprising upload at least a portion of the media using a first connection different from a second connection used to transmit the signal.

17. The method of claim 16, wherein the first connection comprises a wireless connection.

18. The method of claim 1, wherein at least a portion of a connection configured to transmit the signal is wireless.

19. The method of claim 1, wherein the output media is related to substantially current events occurring in game play on the gaming device.

20. A system comprising:
an interface for receiving a signal transmitted between a gaming device and a remote gaming management system that collects gaming-related information from one or more gaming devices;
a signal decoder for associating at least a portion of the signal with media; and
a media output device for outputting the media to a user of the gaming device.

21. A computer program product tangibly embodied in a computer readable medium, the computer program product including instructions that, when executed, perform operations for outputting media to a user of a gaming device, the operations comprising:
monitoring, at a game topper, a signal transmitted between a gaming device and a remote gaming management system that collects gaming-related information from one or more gaming devices;
associating at least a portion of the signal with media;
outputting the media to a user of the gaming device using the game topper.
